(19) United States
(12) Patent Application Publication
(10) Pub. No.: US 2008/0306829 A1
(43) Pub. Date: Dec. 11, 2008

(54) METHOD AND SYSTEM FOR PROMOTING A DEALER IN ONLINE MERCHANDISE

(75) Inventors: Eddy C. Moore, Portland, OR (US); Richard A. Hunt, Portland, OR (US)

Correspondence Address: MARGER JOHNSON & MCCOLLOM, P.C., 210 SW MORRISON STREET, SUITE 400, PORTLAND, OR, 97204, US

(73) Assignee: SEWING CENTER SUPPLY CO., INC., Portland, OR (US)

(21) Appl. No.: 11/761,217

(22) Filed: Jun. 11, 2007

(51) Int. Cl. G06Q 20/00

(52) U.S. Cl. 705/21

(57) ABSTRACT

A method includes providing an online merchandizing web site for a distributor and prompting a customer to select a sponsoring dealer from a list of sponsoring dealers while the customer is at the web site. The customer may select a sponsoring dealer during check out and is associated with the sponsoring dealer. The web site displays a window associated with the sponsoring dealer. The window is being linked to a dealer site-let, which is part of the web site. The dealer site-let comprises promotion information for the sponsoring dealer, such as in-store specials at the dealer's local stores, web coupons, featured class schedules, etc. The distributor handles payment, fulfillment, shipping, and customer service and returns. Furthermore, the sponsoring dealer receives a specified portion of net sale profit for each sale made to the customer from the online merchandizing web site.

### TECHNICAL FIELD

The present disclosure relates generally to a computer network-implemented service, and more particularly to a method and system for promoting a dealer in online merchandise.

### BACKGROUND

Online merchandizing has evolved dramatically in recent years. Many established retailers (e.g., Wal-Mart, Target) have moved aggressively online as an alternative channel to drive more sales. Many small to medium-size dealers are also eager to tap the potential of the Internet. But these small to medium-size dealers may not have the budgets for marketing and advertising as compared to their larger competitors, and in many cases, they may lack the technical know-how or the cash to hire people who possess the necessary skills. One way for these small to medium-size dealers to take advantage of the World Wide web (web) selling power may be to use the services of a portal or a listing site, or to affiliate with a well-known and established online retailer. For example, a portal service may take information from a dealer and put together the information to host a web site for the dealer. However, once the web site is up and running, it may be up to the dealer to attract customers and manage traffic and sales online. The portal service may provide online tutoring for the dealer and provide advice on how to run a successful web site, but may not necessarily manage the day-to-day operation of the web site. As for store directory listings on the Internet, a search-by-zip code feature may provide a list of dealers near to a customer, but these dealers may not be the preferred ones from customer's perspective.

Another problem that many dealers may encounter is that they cannot afford to stock an entire inventory of a manufacturer's or distributor's products. This limits exposure and sales of the manufacturer's or distributor's products in the locales of such dealers. Some manufacturers and wholesale distributors try to broaden availability of their goods by selling online. But this approach tends to undermine the dealer's network; it also tends to reduce customer service, which is important for many types of goods. A related problem is that some dealers adopt online sales with aggressive pricing but cannot afford to provide customer service.

It will be desirable for manufacturers and distributors to be able to offer an entire inventory of their goods in all markets, without requiring all dealers to stock the entire inventory. It will be also desirable for the manufacturers and distributors to offer its goods online without undercutting local dealers and impairing their ability to support and service goods and their customers.

It will be also desirable to promote a dealer in online merchandising which requires little investment and effort on the part of the dealer. It will be further desirable to provide a seamless buying experience for a customer associated with the dealer.

### DESCRIPTION OF EXAMPLE EMBODIMENTS

### Overview

A method provides an online merchandizing web site owned or controlled by a distributor which prompts a customer to select a sponsoring dealer from a list of sponsoring dealers while the customer is at the web site. The customer may select a sponsoring dealer during check out and is thereby associated with the sponsoring dealer. The web site displays a window associated with the sponsoring dealer. The window is being linked to a dealer site-let, which is part of the web site. The dealer site-let comprises promotion information associated with the sponsoring dealer, such as in-store specials at the dealer's local stores, web coupons, featured class schedules, etc. The distributor handles payment, fulfillment, shipping, and customer service and returns. Furthermore, the sponsoring dealer receives a specified portion of net sale profit for each sale made to the customer from the online merchandizing web site.

A system for promoting a dealer in online merchandise comprises a computer hosting an online merchandising web site for a distributor, the web site being accessible by a customer via a network. The computer comprises means for prompting a customer to select a sponsoring dealer and means for associating the customer with the sponsoring dealer. The computer also comprises means for displaying to the customer via the web site a window associated with the sponsoring dealer, the window being linked to a dealer site-let in the web site. The computer further comprises means for notifying the sponsoring dealer of each online sale made to the customer. The system is configured to allocate a specified portion of net sales profit to the sponsoring dealer for each sale made to the customer.

### BRIEF DESCRIPTION OF THE DRAWINGS

The foregoing and other objects, advantages and features will become more readily apparent by reference to the following detailed description in conjunction with the accompanying drawings.

FIG. 1 is a block diagram of an online merchandising system according to one embodiment of the present invention.

FIG. 2 illustrates in further detail the online merchandising system of FIG. 1.

FIG. 3 is a flow diagram illustrating an exemplary method performed by the online merchandizing system of FIG. 1.

FIG. 4 is an exemplary database for storing a list of customers and their associated sponsoring dealers in the online merchandising system of FIG. 1.

FIG. 5 depicts an exemplary screen display of the online merchandising system of FIG. 1.

FIG. 6 depicts an exemplary dealer site-let resulting from the customer invoking the “Your Sponsoring Dealer” button in the featured-window of FIG. 5.

FIG. 7 depicts an exemplary screen display in response to the customer's request to “check-out” in the online merchandising system of FIG. 1

### DESCRIPTIONS

Throughout the following description, the term “web site” is used to refer to a user-accessible network site that implements the basic World Wide web standards for the coding and transmission of hyper-textual documents. These standards may include HTML (the Hypertext Markup Language) and HTTP (the Hypertext Transfer Protocol). It should be understood that the term “site” is not intended to imply a single geographic location, but may include multiple geographically-distributed computer systems that are appropriately linked together. Furthermore, while the following description relates to an embodiment utilizing the Internet and related network protocols, other networks, such as networked interactive televisions, and other protocols may be used as well. In the figures, words and phrases are underlined to indicate a hyperlink to a document or web page related to the underlined word or phrase. In addition, unless otherwise indicated, the functions described herein are preferably performed by executable code, including instructions, running on one or more general purpose computers or on servers. The term customer, as used herein, refers to consumers or end users of a given product or service. The term dealer, as used herein, refers to entities that purchase goods or services for resale to others. The term distributors mainly pertains to sellers of goods or services to dealers, and can also include manufacturers and entities that sell direct to end customers as well as dealers.

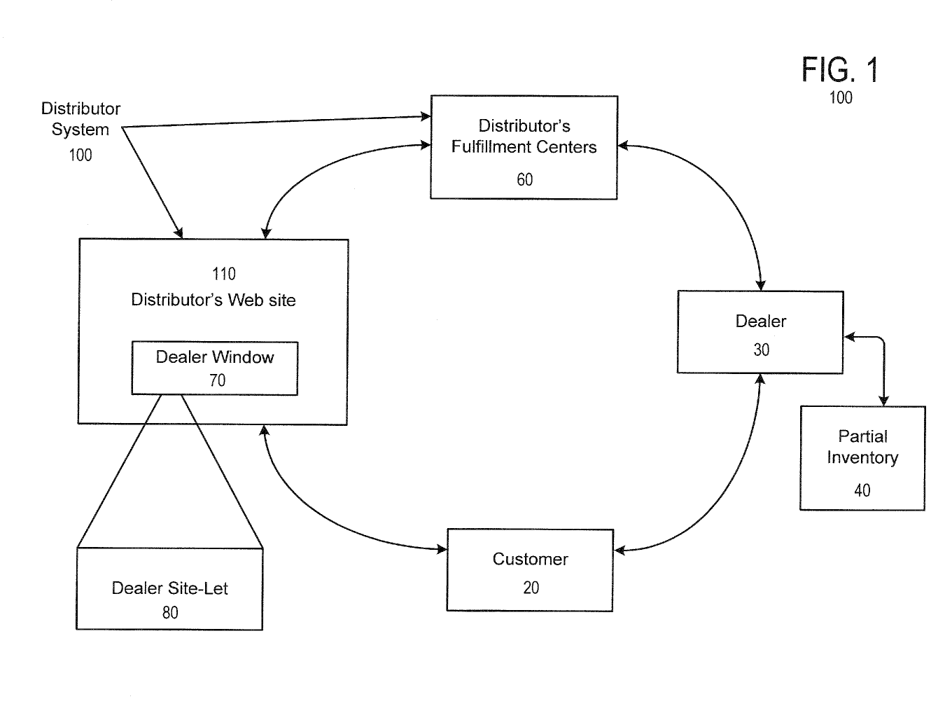

FIG. 1 illustrates an online merchandizing system according to one embodiment of the present invention. For sake of clarity, by way of example, it is presumed that the online merchandising system disclosed herein is configured for merchandizing sewing and craft supplies over the Internet. But the principles of the subject matter disclosed herein may be readily applied to other merchandizing applications sold over the Internet or other networks, such as kitchen supplies, beauty and skincare supplies, clothing, food and beverages, to name a few. By way of example, the online merchandizing system can be used with the exemplary methods and screen displays discussed below.

Referring to FIG. 1, online merchandising system 100, which is owned or operated by a distributor, may include an online merchandizing web site 110 and one or more fulfillment centers 60. The distributor may alternatively contract with a third party (e.g., Internet Service Provider (ISP)) to operate and maintain online merchandizing web site 110 for the distributor. Online merchandizing web site 110 operates similarly to other well-know Internet merchandise web sites (e.g., www.amazon.com), but with distinguishing features, which are described in more detail below. Fulfillment centers 60 may stock an entire inventory of goods for the distributor, and also handle payment, fulfillment, shipping, customer service and returns, and all other aspects related to online merchandise. Fulfillment centers 60 may be located in different geographical locations.

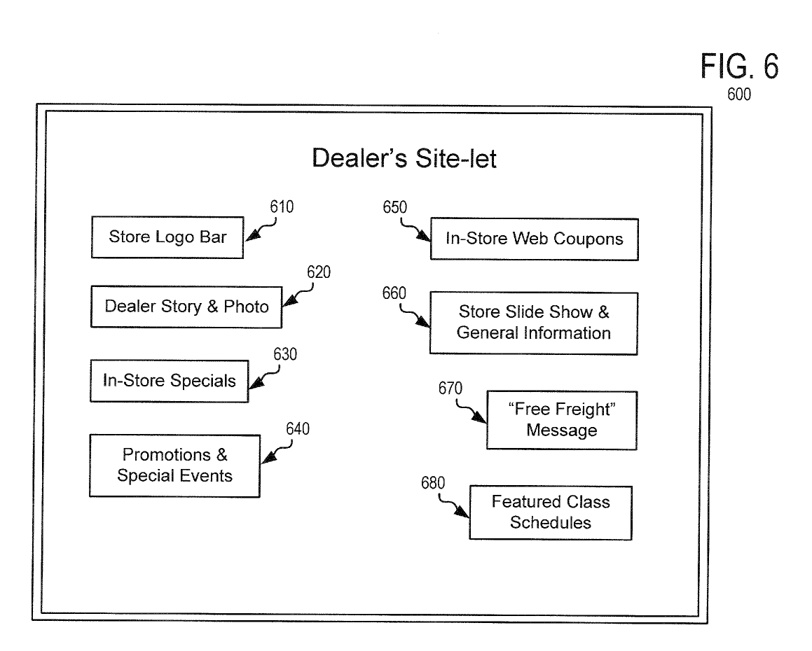

A customer (e.g., customer 20) may visit the distributor's web site 110 for goods and other related service/information. Customer 20 may be prompted to choose a sponsoring dealer from a list of dealers when he checks out from web site 110. This feature allows a customer to be associated with a preferred sponsoring dealer rather than being limited to a set of dealers that he may not prefer. Once the customer is associated with a sponsoring dealer (e.g., dealer 30), a window (e.g., window 70) featuring that sponsoring dealer is displayed at web site 110 each time when the customer visits the site. Window 70 may appear on every page of web site 110 as the customer navigates through the site. A click on window 70 brings the customer to a dealer site-let 80 (described in FIG. 6), which is a customized web page for the dealer. Dealer site-let 80 is part of the distributor's web site 110, and may include promotional information about the sponsoring dealer, e.g., local events, in-store special, class schedules, and other information related to the dealer. The dealer site-let thus serves the purpose to continuously attract customers to dealer's local stores. This unique feature of including a customized dealer site-let for each sponsoring dealer as part of the distributor's web site 110 distinguishes from other well-known online merchandizing web sites, such as www.berninausa.com, which merely associates a customer with a preferred dealer from a list of nearby dealers based on a search-by-zip code feature, and which does not necessarily provide a customized dealer site-let for the preferred dealer.

After customer 20 places an order through the online merchandizing web site 110, fulfillment center 60 handles payment, fulfillment, shipping, customer service and returns, and all other aspects related to online merchandise. In addition to purchasing direct from the distributor's online web site 110, customer 20 may also buy direct from his local dealer (e.g., dealer 30), who may keep a partial inventory of goods (e.g., partial inventory 40). This is especially desirable for customers who purchase items that require assembly, manual installation, or after-purchase service. Buying-direct from local dealers helps the customer to save on freight charges, which presents an attractive alternative to the online merchandise disclosed herein.

For each sale made to a customer, the sponsoring dealer is notified of the transaction and also receives an agreed or otherwise specified portion of the net sale profits from such sale. This in effect expands the dealer's inventory without requiring the dealer to stock an entire inventory. Online customer transactions are journaled in association with the sponsoring dealers. At the end of each business period (e.g., monthly, quarterly), the distributor may provide the sponsoring dealers with a detailed customer activity report, which further relieves dealers from tasks, such as accounting, and tracking of the inventory.

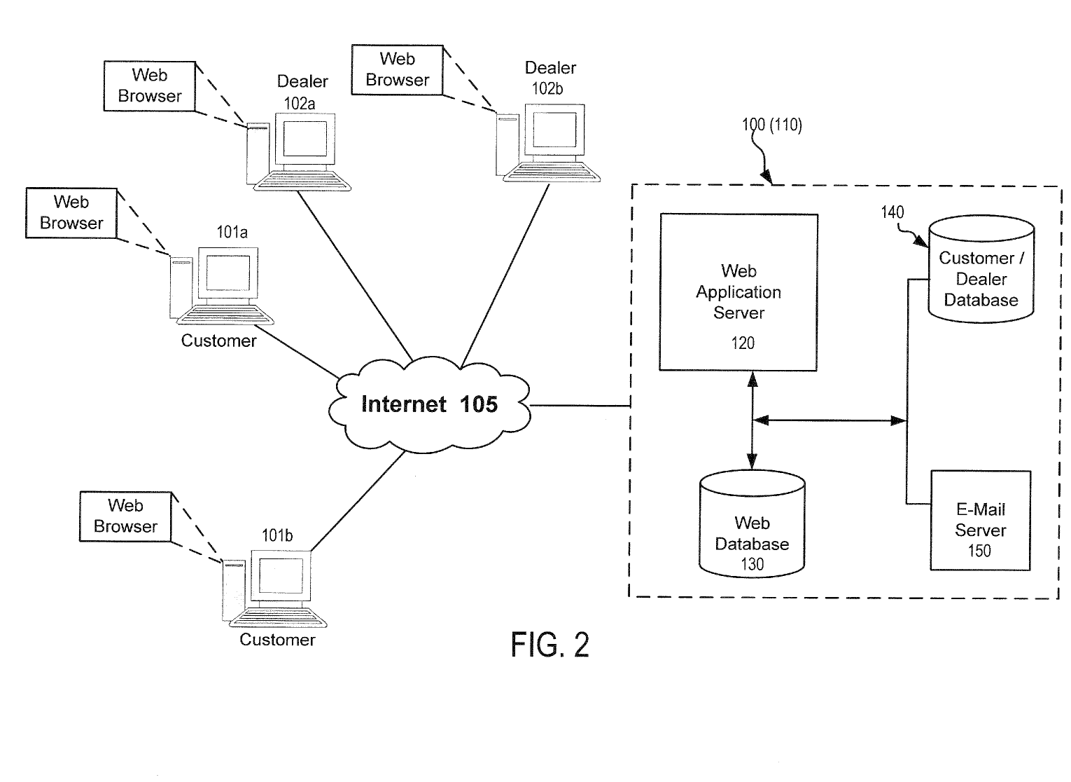

FIG. 2 illustrates in detail the online merchandizing system of FIG. 1. Referring to FIG. 2, online merchandizing system 100, which is coupled to Internet network or “cloud” 105, may include: (a) web application server 120; (b) web database 130; (c) customer/sponsoring dealer database 140, implemented using a commercial database product, such as one from Oracle; and (d) e-mail server 150, which is configured to return an e-mail confirmation message to the customer upon completion of an order. web application server 120 may access web database 130 to generate web pages in response to a customer request. Online merchandizing system 100 may be visualized as online merchandizing web site 110 accessible from a customer's personal computer (e.g., computers 101a, 110b) over the Internet. Computers 101a and 101b may include a monitor for displaying web pages on the monitor's screen, a keyboard, and a “mouse” (which is not shown in FIG. 1). Computers 101a and 101b may run commercially-available web browser applications, such as Microsoft Internet Explorer®, which implements the basic World Wide Web standards such as HTTP and HTML. Computers 101a and 101b may also run commercially available e-mail applications, such as Microsoft Outlook® or Outlook Express®, which may be used to send and receive communications from or to online merchandizing web site 110.

In the embodiment described herein, online merchandizing web site 110 may also be connected via the Internet or other network to servers or computers associated with various dealers, such as 102a and 102b as shown in FIG. 2. Online merchandizing web site 110 may include a computer system and associated content that are accessible via the Internet. Online merchandizing web site may also optionally include content that spans multiple Internet domains, and/or may be implemented using physical servers that are geographically remote from one another.

In other embodiments, web site 110 may be in the form of an Intranet site, and the customer's or dealer's computer may be coupled to the site by a private network.

In other embodiments, online merchandizing web site 110 may be replaced with another type of network site. For example, the various services described herein could alternatively be implemented on a hyper-textual site or browsing area of an online services network such as America Online®, MSN®, or using interactive TV, in which case users may access the site using software that implements non-standard document formats and transfer protocols.

Audio and/or video interfaces may also be provided between the customers and online merchandizing web site 110 to further enhance the customers buying experience online.

The above-described online merchandizing system thus allows manufacturers and distributors to offer goods online without undercutting local dealers and impairing their ability to support and service goods and customers. The online merchandizing system also enables local dealers who do not have the necessary resources to compete online.

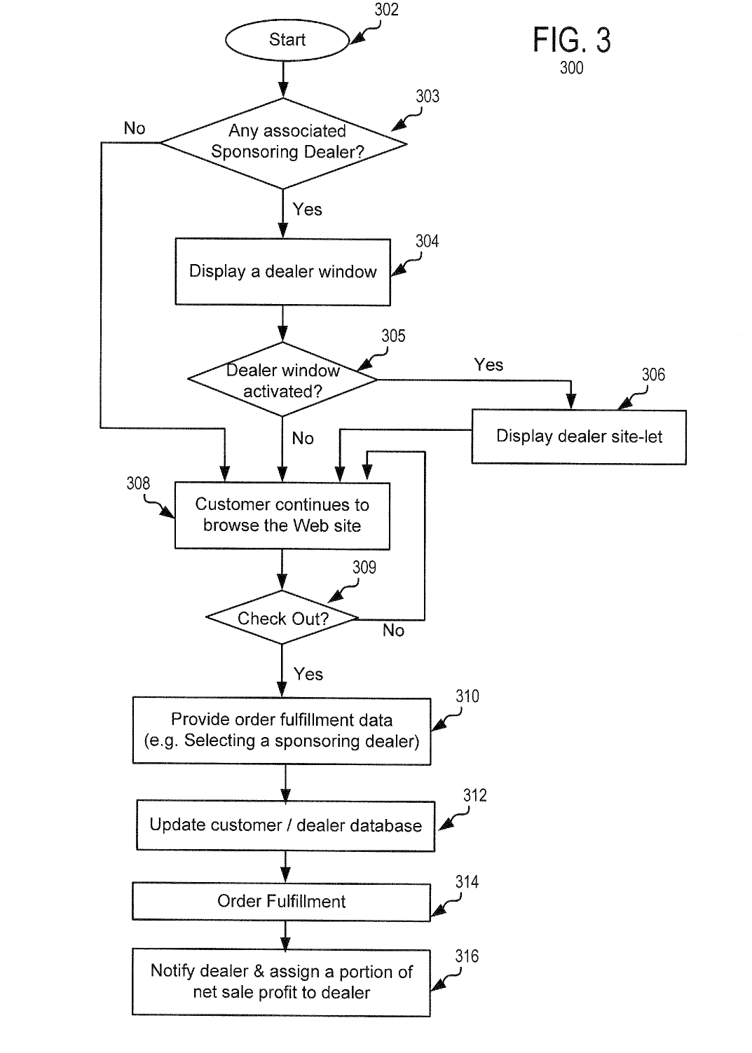

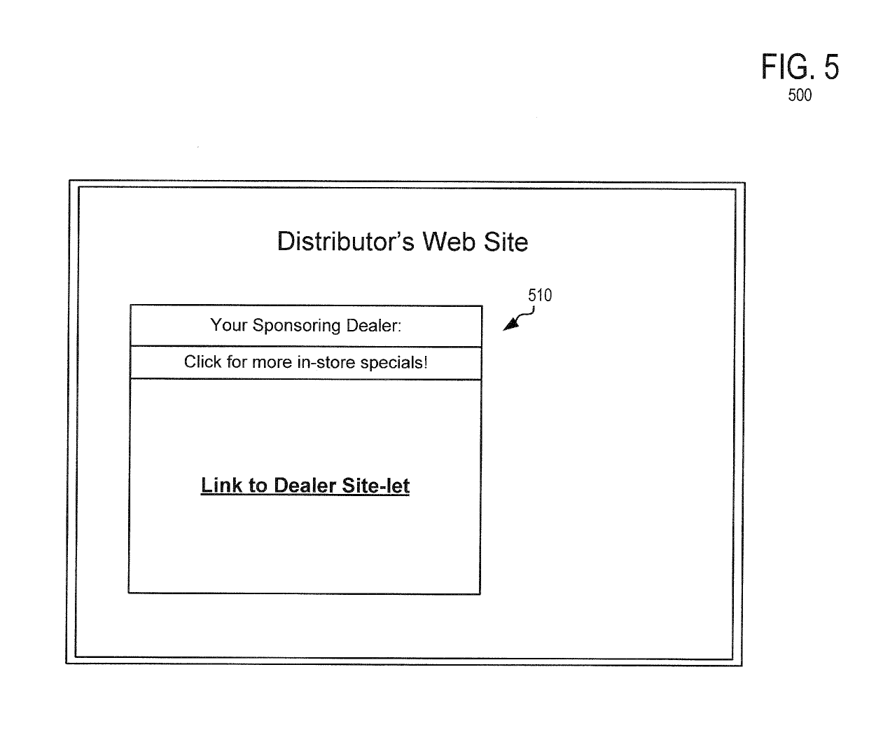

FIG. 3 is a flow diagram illustrating an exemplary method performed by the online merchandizing system of FIG. 1. Method 300 begins at 302, in which a customer may first enter the Uniform Resource Locator (URL) address of online merchandizing web site 110 using an input web page on computer 101a; the input request may be transmitted using HTTP protocol to online merchandizing system 100, which responds to the customer's request by displaying the online merchandising web site's home page on computer 101a. An example web page of online web site 110 is shown in FIG. 5, as will be described later. At 303, method 300 determines if the customer has an associated sponsoring dealer. A so-called “cookie” may be used to immediately identify the sponsoring dealer (a “cookie” is a small text file that is stored on the hard disk of the customer's computer). For example, the sponsoring dealer's name may be stored in the “cookie,” facilitating customer identification in future visits to the web site. The cookie may also store the customer's email address and/or other personal identification information (e.g., name, address, or phone number), which may be referenced to locate the associated sponsoring dealer. Alternatively, the customer may enter a valid email address and/or other identification information, and based on the given information, system 100 may perform a lookup in customer/sponsoring dealer database 140 of FIG. 2 to detect the associated sponsoring dealer.

If the customer is associated with a sponsoring dealer, at step 304, method 300 displays a window featuring the sponsoring dealer as the customer navigates through the distributor's web site. A click on the window brings the customer to a dealer site-let, which is a customized web page in web site 110. At step 305, method 300 determines if the customer has activated the window, e.g., by clicking on it. If the customer activates the window, then at step 306, method 300 displays the dealer site-let associated with the sponsoring dealer. Otherwise, at step 308, the customer may continue to browse online merchandizing web site 110. At step 309, method 300 determines if a check-out request is invoked. If the check-out request is invoked, at step 310, the customer is prompted to enter order fulfillment data, which includes selection of a sponsoring dealer if not already selected, or if the customer wants to change sponsoring dealer. At step 312, the customer/sponsoring dealer database 140 (which will be described next) of FIG. 2 is updated to reflect the proper association between a customer and his/her sponsoring dealer. At step 314, the customer order is executed and the online transaction is fulfilled. At step 316, the sponsoring dealer is notified of the transaction, and a specified portion of net sales profit is credited to the sponsoring dealer's account.

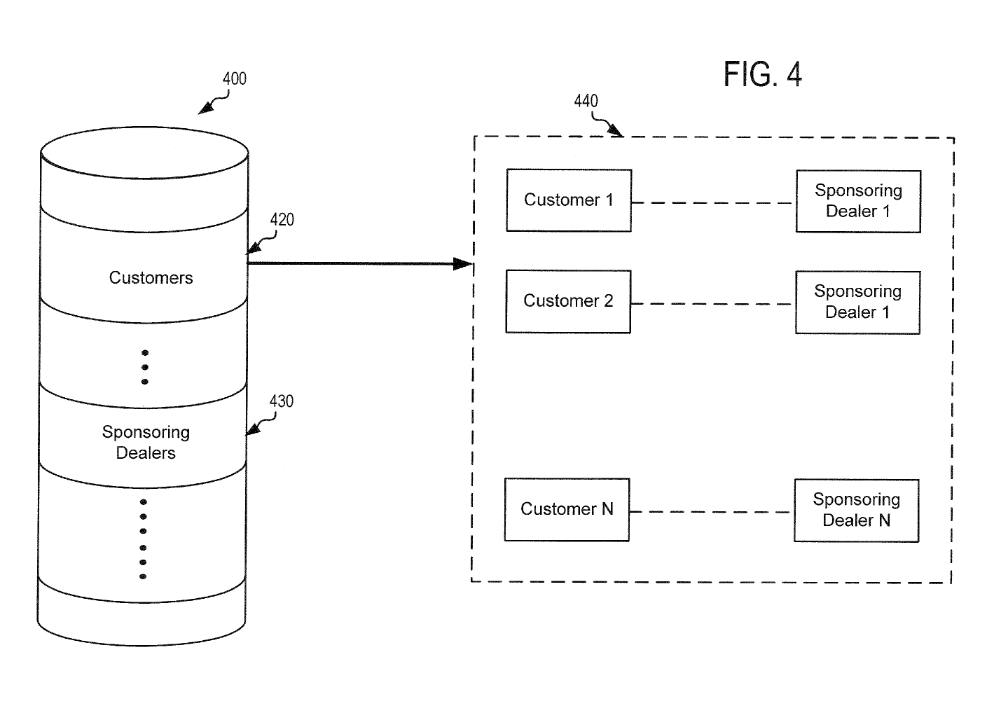

FIG. 4 is an exemplary database 400 for storing a list of customers and the associated sponsoring dealers in the online merchandizing system of FIG. 1. Database 400 includes a plurality of storage areas, such as customer storage area 420 and dealer storage area 430. Storage area 420 may store information for customers and the associated sponsoring dealers. Storage area 420 may include matrix 440, in which each customer (customer 1 to customer N) is identified by the customer's e-mail address, name, address, phone number, and/or other identifiers. Matrix 440 is updated whenever a customer selects a new or different sponsoring dealer when he checks out. Storage area 430 may store information for dealers, e.g., dealers' names, addresses, and/or other appropriate identifiers.

FIG. 5 depicts an exemplary screen display of the distributor's online merchandizing web site 110. Referring to FIG. 5, the example web page shown on screen display 500 may include window 510, which features a sponsoring dealer associated with a customer (we assume that the customer is currently browsing the distributor's web site 110). A click on that window brings the customer to a dealer site-let, which is a customized web page in the distributor's web site 110. Window 510 may be configured as an animated window, displaying various images associated with the sponsoring dealer. The example web page may also include other information and images that are generally displayed and used in an online merchandizing web site, which are not displayed herein.

FIG. 6 depicts an exemplary screen display of a dealer site-let resulting from the customer clicking on window 510 in FIG. 5. Referring to FIG. 6, the example web page shown on screen display 600 is a customized web page for each dealer, which may include one or more of the following items:
Dealer's store logo bar 610, which may link to the dealer's existing web site;
Dealer's story & photo 620, which may include dealer's email address & web links;
In-store specials 630, which provide information on special savings for items that are not available online;
Promotion & special events at the dealer's local stores 640;
Dealer's in-store web coupons 650, which may be redeemed at the dealer's local stores;
Store slide show and general information 660, e.g., store hours, store locations, and maps & directions;
“Free-Freight” message 670 to encourage customer shop at the dealer's stores and save on shipping charges;
Featured class schedules 680.
   The above is not an exhaustive list. The information contained in the dealer site-let may be updated on a regular basis as part of the services provided by the distributor.

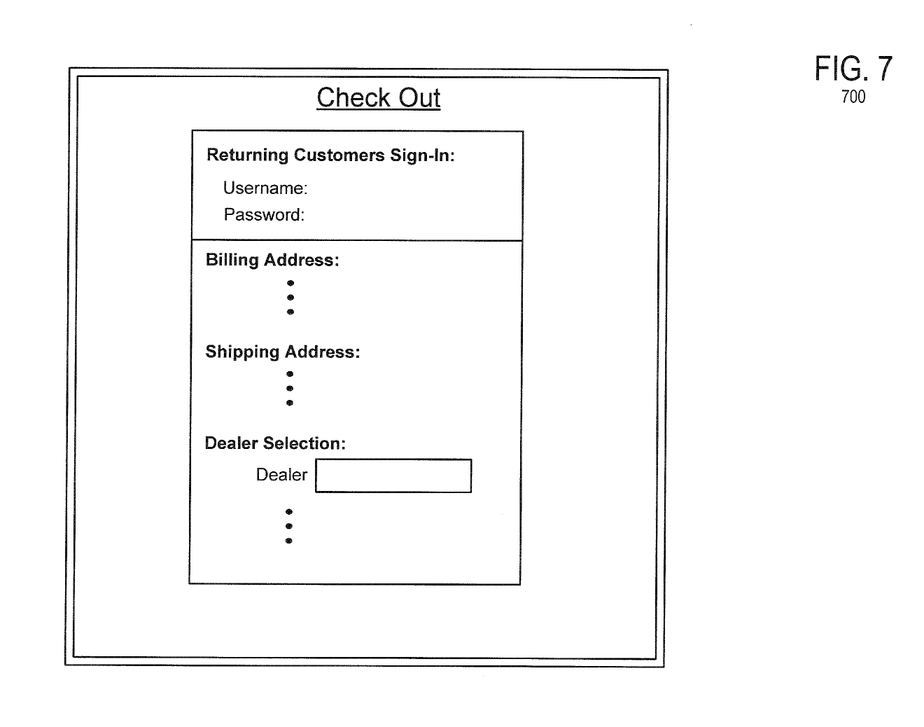

FIG. 7 depicts an exemplary screen display in response to the customer's request to “check-out” in the online merchandising system of FIG. 1. Referring to FIG. 7, the example web page shown on screen display 700 may include fields into which the customer may enter information associated with the purchase. The requested data may include customer's name, address, email address, and/or telephone number. The customer may also be asked to specify a sponsoring dealer from the list of dealers, as shown here. In one embodiment, the system may request account information (e.g., username and password) from returning customers to expedite the check-out process.

The above described method and system allow dealers to compete effectively in the online retail space by attracting customers into the dealer's local stores. The dealers share in revenues generated from customer purchases without stocking an entire inventory, in effect expanding the dealers' product offering. The online merchandizing system also allows manufacturers and distributors to offer goods online without undercutting local dealers and impairing their ability to support and service goods and customers.

Finally, those of skill in the art will appreciate that the method and system described and illustrated herein may be implemented in software, firmware or hardware, or any suitable combination thereof. Preferably, the method and system are implemented in software, for purposes of low cost and flexibility. Those of skill in the art will appreciate that the method and system may be implemented in logic or software code encoded in one or more tangible media for execution in a machine. Alternative embodiments are contemplated and are within the spirit and scope of the following claims.

1. A method for promoting a dealer, comprising:
providing an online merchandizing web site for a distributor;
prompting a customer to select a sponsoring dealer from a list of sponsoring dealers while the customer is at the web site;
associating the customer with the sponsoring dealer;
displaying to the customer via the web site a window associated with the sponsoring dealer, the window being linked to a dealer site-let in the web site;
notifying the sponsoring dealer of each online sale made to the customer;
allocating a specified portion of net sales profit to the sponsoring dealer for each sale made to the customer; and
the distributor handles payment, fulfillment, shipping, and customer service and returns.

2. A method for providing an online merchandising web site for a distributor, comprising:
prompting a customer to select a sponsoring dealer from a list of sponsoring dealers while the customer is at the web site;
associating the customer with the sponsoring dealer;
displaying to the customer via the web site a window associated with the sponsoring dealer, the window being linked to a dealer site-let in the web site;
notifying the sponsoring dealer of each online sale made to the customer; and
allocating a specified portion of net sales profit to the sponsoring dealer for each sale made to the customer.

3. The method of claims 2, in which the web site is configured for merchandizing sewing and craft supplies over the Internet.

4. The method of claims 2, in which the dealer site-let comprises information associated with the sponsoring dealer.

5. The method of claim 4, in which the information included in the dealer site-let comprises one or more of the following:
in-store specials and web coupons;
store locations and hours;
a “Free-Freight” message; and
featured-class schedules.

6. The method of claim 2, in which the distributor handles payment, fulfillment, shipping, and customer service and returns.

7. The method of claims 2, in which prompting the customer to specify a sponsoring dealer while the customer is at the web site comprises prompting the customer to specify a sponsoring dealer from the list of sponsoring dealers when the customer checks out from the web site.

8. The method of claim 2, in which the window associated with the sponsoring dealer is an animated window.

9. The method of claim 2, in which associating the customer with the one of sponsoring dealers from the list of sponsoring dealers comprises storing information associated with the customer in a database.

10. The method of claim 9, in which the information associated with the customer comprises one or more of the following:
a name;
an address;
an e-mail address;
a telephone number; and
an associated sponsoring dealer.

11. The method of claim 1, in which the customer is encouraged to buy directly from the sponsoring dealer.

12. The method of claim 1, further comprising providing a detailed customer activity report to the sponsoring dealers.

13. A system for promoting a dealer, the system comprising:
a computer hosting an online merchandizing web site for a distributor, the web site being accessible by a customer via a network, the computer comprises,
means for prompting a customer to select a sponsoring dealer from a list of sponsoring dealers while the customer is at the web site;
means for associating the customer with the sponsoring dealer;
means for displaying to the customer via the web site a window associated with the sponsoring dealer, the window being linked to a dealer site-let in the web site; and
means for notifying the sponsoring dealer of each online sale made to the customer.

14. The system of claim 13, in which the computer further comprises means for allocating a specified portion of net sales profit to the sponsoring dealer for each sale made to the customer.

15. The system of claim 13, in which the computer further comprises means for handling payment, fulfillment, shipping, and customer service and returns.

16. The system of claim 13, in which the computer communicates with the customer via the Internet.

17. The system of claim 13, in which the system is configured to display messages that encourage the customer to buy directly from the sponsoring dealer.

18. The system of claim 13, in which the system further comprises:
a web application server;
an email server; and
a database to associate the customer with the sponsoring dealer.

19. Logic encoded in one or more tangible media for execution in a machine and when executed operable to:
provide an online merchandizing web site for a distributor;
prompt a customer to select a sponsoring dealer from a list of sponsoring dealers while the customer is at the web site;
associate the customer with the sponsoring dealer;
displaying to the customer via the web site a window associated with the sponsoring dealer, the window being linked to a dealer site-let in the web site;
notify the sponsoring dealer of each online sale made to the customer; and
allocate a specified portion of net sales profit to the sponsoring dealer for each sale made to the customer; and
the distributor handles payment, fulfillment, shipping, and customer service and returns.

20. A method, comprising:
providing an online merchandizing web site for a distributor;
displaying to a customer via the web site a window associated with a sponsoring dealer, the window being linked to a dealer site-let in the web site.

21. The method of claim 20, in which the dealer site-let comprises information associated with the sponsoring dealer.

22. The method of claim 21, in which the information included in the dealer site-let comprises one or more of the following:
in-store specials and web coupons;
store locations and hours;
a “Free-Freight” message; and
featured-class schedules.

23. The method of claim 20, further comprising
prompting the customer to select a sponsoring dealer from a list of sponsoring dealers while the customer is at the web site; and
associating the customer with the selected sponsoring dealer.

24. The method of claim 20, further comprising
notifying the sponsoring dealer of each online sale made to the customer;
allocating a specified portion of net sales profit to the sponsoring dealer for each sale made to the customer; and
the distributor handles payment, fulfillment, shipping, and customer service and returns.
